(19) United States
(12) Patent Application Publication
(10) Pub. No.: US 2008/0133267 A1
(43) Pub. Date: Jun. 5, 2008

(54) SYSTEM AND METHOD FOR INDIVIDUALIZED PATIENT CARE

(76) Inventors: George Maltezos, Fort Salonga, NY (US); Axel Scherer, Laguna Beach, CA (US)

Correspondence Address: Steinfl & Bruno, 301 N Lake Ave Ste 810, Pasadena, CA, 91101, US

(21) Appl. No.: 11/947,758

(22) Filed: Nov. 29, 2007

Related U.S. Application Data
(60) Provisional application No. 60/861,933, filed on Nov. 30, 2006.
(60) Provisional application No. 60/989,918, filed on Nov. 23, 2007.

(51) Int. Cl. G06Q 50/00

(52) U.S. Cl. 705/2

(57) ABSTRACT

A system for individualized patient care, including: a microfluidic bodily fluid reader, programmable to search for different species or components in a bodily fluid inserted in the microfluidic bodily fluid reader; a local computer analysis unit configured to receive data from the microfluidic reader; and a centralized server connectable to the local computer analysis unit. Additionally, a method for monitoring a patient's health is shown, including: reviewing medical history and current medical status of a patient; determining which species of a patient's bodily fluid should be monitored; preparing a microfluidic bodily fluid reader containing reagents for analysis of the species to be monitored; saving patient history and patient's current state; testing the patient with the microfluidic bodily fluid reader; analyzing patient data based on the testing and issuing an alert in case an abnormality is found; further analyzing the patient data for trends indicating that other tests should be added or removed; and adding or removing the other tests through personalization of the microfluidic bodily fluid reader.

### CROSS REFERENCE TO RELATED APPLICATIONS

This application claims priority to U.S. Provisional Application Ser. No. 60/861,933 filed on Nov. 30, 2006, entitled “Data Analysis Network for Individualized Patient Care Based on Large Scale Personalized Data Collection” and U.S. Provisional Application Ser. No. 60/989,918 filed on Nov. 23, 2007, entitled “Data Analysis Network for Individualized Patient Care Based on Large Scale Personalized Data Collection”, the content of both of which is incorporated herein by reference in their entirety. This application is related to U.S. patent application Ser. No. 11/439,288, entitled “High Throughput Multi-Antigen Microfluidic Fluorescence Immunoassays”, also incorporated herein by reference in its entirety.

### TECHNICAL FIELD

The present application relates to health care systems and methods. In particular, the present application describes a system of personalized data collection for blood and bodily fluid species tied together by a data collection network and software used to analyze the data in both a personalized and anonymous way in order to improve patient outcomes and medical knowledge.

### BACKGROUND

Microfluidic chips have been developed which allow blood or other bodily fluids to be analyzed for various different protein levels, cancer and disease marker and also viral infections. Reference can be made to U.S. patent application Ser. No. 11/297,651 entitled “Prototyping Methods and Devices for Microfluidic Components” and U.S. patent application Ser. No. 11/439,288, entitled “High Throughput Multi-antigen Microfluidic Fluorescence Immunoassays”, both of which are incorporated herein by reference in their entirety. Those applications show a microfluidic chip or reader adapted to analysis of bodily fluids.

These devices are cheap and promise to be widely distributable. Such devices allow a large amount of available medical data that was previously unavailable that can now be collected. In particular, the microfluidic ability of taking bodily fluids allows the possibility of using a much reduced amount of blood or bodily fluid for each analysis, thus allowing various tests to be taken on the fluid without requiring much fluid or inconvenience to the patients. With these devices only a finger prick (microliter) or less is needed when compared to previous methods (where milliliters where needed). Moreover, sampling can be done at home, without a phlebotomist or trained technician.

### SUMMARY

According to a first aspect, a system for individualized patient care is provided, comprising: a microfluidic bodily fluid reader, programmable to search for different species or components in a bodily fluid inserted in the microfluidic bodily fluid reader; a local computer analysis unit configured to receive and analyze data from the microfluidic reader; and a centralized server connectable to the local computer analysis unit, wherein the microfluidic reader is preferably adapted to be personalized through selection of the different species or components to be searched for, upon a determination based, at least in part, on results of comparisons made through the centralized server.

According to a second aspect, a method for monitoring a patient's health is disclosed, comprising: reviewing medical history and current medical status of a patient; deciding which species (such as a protein) of a patient's bodily fluid should be monitored; preparing a microfluidic bodily fluid reader for analysis of the species to be monitored; saving patient history and patient's current state; testing the patient with the microfluidic bodily fluid reader; analyzing patient data based on the testing and issuing an alert in case an abnormality is found; further analyzing the patient data for trends indicating that other tests should be added or removed; and adding or removing the other tests through personalization of the microfluidic bodily fluid reader.

According to a third aspect, a large scale medical data monitoring method, comprising: searching for different species or components in a bodily fluid of a patient, through insertion of the bodily fluid in a microfluidic bodily fluid reader; receiving medical data from the microfluidic reader at a local computer analysis unit; sending received medical data from the local computer analysis unit to a centralized server; and comparing medical data of people in a first category with medical data of people in a second category to determine whether the people in the first category have a good response to a certain drug with respect to the people in the second category.

According to a fourth aspect, a method for periodically monitoring a disease marker, comprising: searching for the disease marker through a microfluidic bodily fluid reader programmable to search for different species or components in a bodily fluid inserted in the microfluidic bodily fluid reader; analyzing data from the microfluidic bodily fluid reader at a local computer analysis unit, the local computer analysis unit configured to be connected to a centralized server; alerting a doctor if the disease marker appears; and further performing the searching periodically.

Further embodiments of the present application are shown in the present specification, drawings and claims.

When further analyzing the patient data for trends indicating that other tests should be added or removed, the patient data can be compared to anonymous data in order to determine how the patient is doing with regards to one or more statistical cohorts. Based on comparison between the patient data and the anonymous data, the test of the patient can be changed or the patient be warned.

In accordance with the present disclosure, data mining of protein detection information can be used to bring much more data to the medical decision making process. Lifetime protein levels can easily be stored and evaluated in light of all other available medical information (age, height, weight, blood pressure, surgeries, medicine use, medical history etc.). Risk factors can be evaluated in terms of individual and group response. Also in this case, actions can be taken like in the above paragraph, patient and doctor notified, fluid reader changed, warnings issued and so on.

In accordance with the present disclosure, if people in a first category (e.g., a category of overexpressors containing people who overexpress a certain protein) have a good protein response to a certain drug but people in a second category have a poor response to that drug, the data can help advise the doctor on the best course of action. This has ramifications for drug companies as well as doctors and patients as they can quickly see what the effects of their drugs are in certain populations and prescribe those drugs toward those who will see the most positive effects and away from those who will see the worst. In particular, the results are quick because the above mentioned microfluidic chips allow the results to be taken in real time, thus telling the user in a few minutes what the results are, so that doctors can deal right away with this kind of information.

### BRIEF DESCRIPTION OF THE FIGURES

FIG. 1 is a block diagram showing the system according to the present disclosure.

FIG. 2 shows a flowchart outlining a series of steps that could occur when a patient visits a doctor.

FIG. 3 shows a further flowchart outlining a series of further steps that could occur when the patient receives the customized chips or readers at home.

FIG. 4 shows another flowchart outlining a series of possible steps that could occur when the patient returns to the doctor.

### DETAILED DESCRIPTION

The present disclosure deals with a data analysis network or system based on the use of a microfluidic reader or chip such as the one disclosed above.

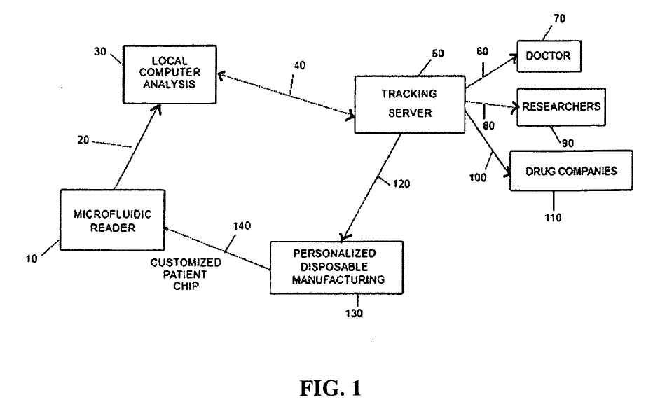

As shown in FIG. 1, the microfluidic reader (10) sends raw data (20) to a local computer analysis unit or device (30).

With reference to the microfluidic reader (10), such reader is an individual data collection unit that can be programmed to search for different species in the blood or, more generally, bodily fluid (such as saliva, urine, vaginal fluids, breast milk, pus, tears, earwax, mucous, feces and semen) for the individual who will be using the chip. The species to be searched could be proteins, white blood cells, cholesterol, etc. A possible reader and method for programming are described in US Pat. App. S/N 2006/0263818 to Scherer, Kartalov, Anderson and Taylor, incorporated herein by reference in its entirety. The choice of proteins to be searched for can be handled as described in the present application. Also other types of chips or microreaders can be used, like those disclosed in U.S. patent application Ser. No. 11/874,211 entitled “Control Arrangement for Microfluidic Devices and Related Methods and Systems”, which is also incorporated herein by reference in its entirety.

The use of data collection unit (10) in the system described in FIG. 1 allows a patient's entire medical history to be taken into account, various risks to be determined, and an analysis of which blood or bodily fluid species or component (e.g., a protein) should be looked for.

In particular, the microfluidic reader (10) can be programmed based on information the local computer analysis unit (30) and a tracking server (50) receive from the individual and all other users in order to make sure that all blood species of interest are being looked for. In particular, the local computer analysis unit (30) and the tracking server (50) take the results of the current blood test and compare the current blood test to several data sets:
1) Individual patient history: monitoring of trends in test results over time, correlation to any factor that might be affecting outcome (e.g., time of day, month, day of week etc.)
2) Presence of additional inputs, such as blood pressure, stress level, food intake as reported by patient, medicines taken, race, sex, age, weight, amount of exercise, previous blood levels, family history etc.
3) Evaluation of current data in terms of anonymous aggregate data from all devices

The data are reported anonymously to a central server (see tracking server (50)), and then the central server looks for trends among a broad range of people who have similar profiles or unique characteristics, and looks for patterns that could warn of impending disease. See also item 3) above.

If a new relationship appears, or one test shows that another test should now also be performed, the software can update the individual's chip in order to reflect the change in information, based both on the individual and the group. For example, if the software sees a pattern, it decides that a person should be checked for protein X to watch for disease Y, and it provides for sending to the patient a set of chips containing a test that the software believes the patient should be monitored for. In particular, with reference to FIG. 1, the chip is personalized or customized in step (130) and then the customized chip (140) is sent to the patient, thus providing the patient with a new chip that fits into the reader (10). Personalization of the chip used by the reader (10) amount to programming of the reader (10). Such programming is described, for example, in the above mentioned U.S. patent application Ser. No. 11/439,288, incorporated herein by reference in its entirety. As already mentioned above, readers for reading fluid species different than proteins (e.g., cholesterol) can be provided.

Additionally, it can be decided through the local computer analysis unit (30) and the tracking or centralized server (50), if the patient agrees, to add additional tests or changing the tests in order to perform research across specific groups of individuals with certain characteristics of interest to researchers, or to take into account the changing health of the patients, especially when the entire medical history is taken into account. Drugs can be watched and proven in a much safer manner if information is collected across most users and damaging side effects can be caught. Additionally sub populations can be identified that will and will not benefit from the medication based on the available data.

Furthermore, the use of unit (10) in the system shown in FIG. 1 allows risk such as cancer can be evaluated and cancer markers can be looked for. As soon as a cancer marker is detected the software can tell the patient and the doctor that something is troublesome. For example, the unit (10) can have a readout that alerts the user or her doctor, and a remedy can be taken as early as possible.

Moreover, other diseases, such as multiple sclerosis, can be monitored and blood species that indicate a prelude to a worsening of the patients health can be vigilantly monitored in order to begin treatments designed to minimize the disease progress as quickly as possible. In particular, as soon as a cancer marker appears, the user/doctor can be immediately alerted, allowing treatment to commence, often months earlier than if one waited for symptoms.

Local computer analysis unit, device or station (30) is connected to the tracking server (50) through a two-way data transfer connection (40), the purpose of which is to warn the patient. Connection (40) can be effected through IP address over the Internet or by phone or other system of data communication and can comprise safeguards (e.g., encryption of patient information or collection similar to collection of user preferences in cable or Tivo® environments) to guard patient privacy, while still allowing aggregate data to be collected and used in order to make decisions about what species are to be tested for. Connection (40) can also be a one-way connection, if the doctor and/or the patient decides to communicate the results to the patient.

In particular, the tracking server (50) can have different functions. A first function could be that of sending patient specific information (60) to the doctor (70). A second function could be that of sending anonymous information (80) to researchers (90). A third function could be that of sending anonymous information (100) to drug or biotech companies (110).

On the tracking server (50) side, all available medical data are collected, including the data from the home devices described elsewhere and correlations are made between patient health and test results and anonymous aggregate data in order to find factors which determine what levels of blood species are troubling, which are safe, and how a patient is likely to perform based on what other similar patients have experienced. This data can be stored such that children and relatives can have access to medical information of their genetic forebears in order to make more closely applicable medical decisions.

Additionally, epidemiological studies and monitoring can be done with such a system. For example, if somebody is looking for a disease marker, for instance H5N1 antibodies, as soon as a person has the antibodies an alert will be sounded. If an outbreak of a highly contagious disease is found, the system of FIG. 1 can be programmed to look for signs of disease and alert authorities to a cluster of sick people. In particular, at the time of manufacture, the chemicals needed to search for the species of interest are loaded onto the microfluidic reader (10), for example in ready-to-use form or lyophilized. The selection of which species to put into the reader is made by the tracking server (50), which will direct an automated machine to put the correct chemicals into the microfluidic reader (10) in order to prevent further spread of the disease. In particular, software of the tracking server (50) can communicate with an automated filing device to program the personalized microfluidic chip and ship it to the patient. As already indicated above, this personalized manufacturing step is represented by box (130) shown in FIG. 1, where an automated system (not shown in the figure) loads the reader (10) with appropriate chemicals and then sends the programmed reader to the patient.

The system of FIG. 1 can constantly monitor many people and trace the first person to contract the disease in order to localize the outbreak and find all of the people the first patient has had contact with. For example, if “everyone” has to be searched for a disease X, then “all” readers are loaded with the proper marker and, as soon as someone gets disease X, it is reported to the tracking server (50), and the infection can be taken care of.

This system combined with networked data collectors (see, e.g., researchers (90) and drug or biotech companies (110)) can be used to make better individual patient decisions based on all available information and can also act as a pandemic monitor.

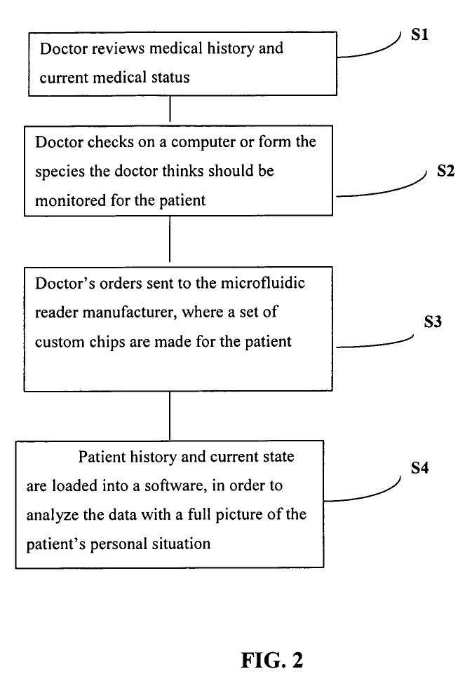

FIG. 2 shows a flowchart outlining a series of steps that could occur when a patient visits a doctor. As shown in step S1, the doctor reviews the medical history and the current medical status of the patient. In step S2, the doctor checks on a computer or form the species the doctor thinks should be monitored for this patient. Step S3 indicates that the patient's history and current state are loaded into a software, in order to analyze the data with a full picture of the patient's personal situation.

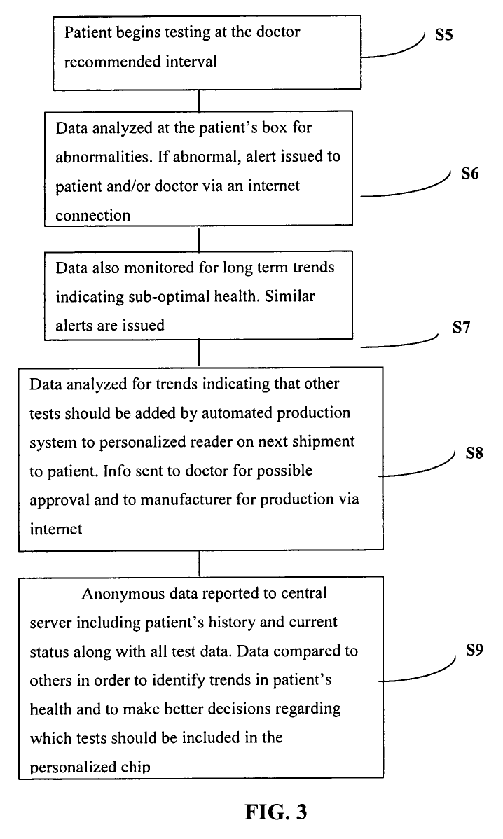

FIG. 3 shows a further flowchart outlining a series of further steps that could occur when the patient receives the customized chips or readers at home. As shown in step S5, the patient begins testing at the doctor recommended interval. In step S6, data is analyzed at the patient's box for abnormalities. If an abnormality is found, an alert is issued to the patient and/or the doctor, e.g. through an Internet connection. Step S7 indicates that the data is also monitored for long-term trends to see whether sub-optimal health is indicated. If so, similar alerts to those shown in step S6 above are issued. As shown in step S8, patient's data are analyzed for trends indicating that other tests should be added (e.g., by an automated production system) to a personalized reader on the next shipment to the patient. Information can be sent to the doctor (for possible approval) and to the manufacturer (for production) via Internet. In step S9, anonymous data are reported to the central server, including the patient's history and current status, along with all test data. Data are compared to the data of other patients in order to identify trends in the patient's health and to make better decisions regarding which tests should be included in the personalized chip or reader. This data can also be used for many other purposes, including testing by drug or biotech companies, monitoring of epidemics, etc.

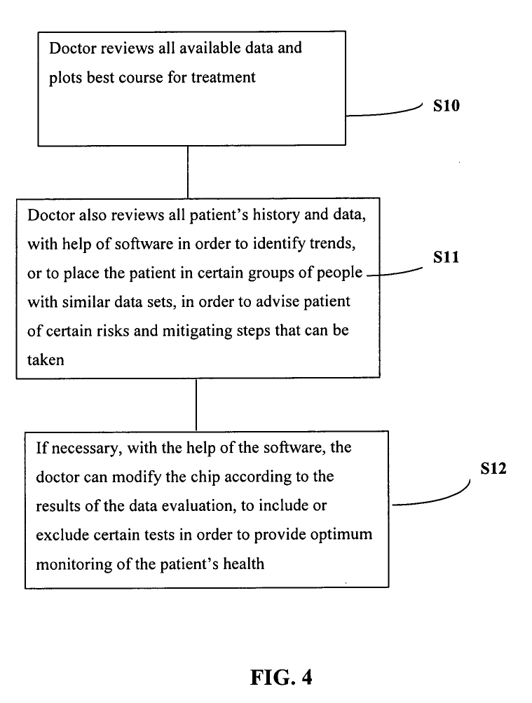

FIG. 4 shows another flowchart outlining a series of possible steps that could occur when the patient returns to the doctor. As shown in step S10, the doctor reviews all available data and plots the best course for treatment. In step S11, the doctor also reviews all patient's history and data, with the help of software in order to identify trends, or to place the patient in certain groups of people with similar data sets, in order to advise the patient of certain risks and mitigating steps that can be taken. As further indicated by step S12, if necessary, with the help of software, the doctor can modify the chip or reader according to the results of the data evaluation, to include or exclude certain tests in order to provide optimum monitoring of the patient's health.

It is to be understood that the disclosures are not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. Thus, for example, reference to “a microfluidic bodily fluid reader” includes a plurality of such readers, reference to “a local computer analysis unit” includes a plurality of such units and reference to “a centralized server” includes reference to one or more servers as well as equivalents thereof known to those skilled in the art and so forth. As used in this specification the term a “plurality” refers to two or more references as indicated unless the content clearly dictates otherwise.

Unless defined otherwise, all technical and scientific terms used herein have the same meaning as commonly understood by one of ordinary skill in the art to which the disclosure pertains. Although any methods and materials similar or equivalent to those described herein can be used in the practice for testing of the disclosure(s), specific examples of appropriate materials and methods are described herein.

The examples set forth above are provided to give those of ordinary skill in the art a complete disclosure and description of how to make and use the embodiments of the devices, systems and methods of the disclosure, and are not intended to limit the scope of what the inventors regard as their disclosure. Modifications of the above-described modes for carrying out the disclosure that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

While specific embodiments of the subject disclosures are explicitly disclosed herein, the above specification are illustrative and not restrictive. It will be understood that various modifications may be made without departing from the spirit and scope of the disclosure. Many variations of the disclosures will become apparent to those skilled in the art upon review of this specification and the embodiments below. The full scope of the disclosures should be determined by reference to the embodiments, along with their full scope of equivalents and the specification, along with such variations. Accordingly, other embodiments are within the scope of the following claims.

What is claimed is:

1. A system for individualized patient care, comprising:
a microfluidic bodily fluid reader, programmable to search for different species or components in a bodily fluid inserted in the microfluidic bodily fluid reader;
a local computer analysis unit configured to receive and analyze data from the microfluidic reader; and
a centralized server connectable to the local computer analysis unit.

2. The system of claim 1, wherein the microfluidic reader is adapted to be personalized through selection of the different species or components to be searched for, upon a determination based, at least in part, on results of comparisons made through the centralized server.

3. The system of claim 2, wherein the comparisons are made between the bodily fluid under test and one or more of the following: individual patient history; patient's blood pressure; patient's stress level; patient's food intake; medicines taken by the patient; patient's race; patient's sex; patient's age; patient's weight; patient's amount of exercise; previous blood levels; family history; and anonymous aggregate data from other patients.

4. The system of claim 2, wherein the personalized microfluidic reader is provided to the patient to replace the microfluidic reader currently used by the patient.

5. The system of claim 2, wherein the microfluidic reader is personalized by changing the tests in order to perform research across specific groups of patients with certain characteristics or in order to take into account the changing health of the patients.

6. The system of claim 1, wherein the centralized server is connected to the local computer analysis unit through a one-way or two-way data transfer connection.

7. The system of claim 6, wherein the two-way data transfer connection is selected from one or more of the following connections: an Internet connection, and an encrypted connection.

8. The system of claim 1, wherein the centralized server is connectable to at least one between a doctor, researchers and biotech companies, wherein connection to the doctor is for sending patient specific information to the doctor, and connection to the researchers or biotech companies is for sending anonymous information to the researchers or biotech companies.

9. The system of claim 1, wherein patient data are stored on the centralized server to be made available for the patient or patient's relatives.

10. The system of claim 1, wherein lifetime patient data are stored and analyzed on the centralized server.

11. The system of claim 2, wherein personalization of the microfluidic reader occurs automatically.

12. The system of claim 1, wherein the system acts as a pandemic monitor.

13. The system of claim 1, wherein the microfluidic reader is programmed to include chemicals for a species of interest in epidemiological studies and monitoring.

14. The system of claim 1, wherein the bodily fluid is selected from the group consisting of blood, saliva, urine, vaginal fluids, breast milk, pus, tears, earwax, mucous, feces, and semen.

15. A method for monitoring a patient's health comprising:
reviewing medical history and current medical status of a patient;
deciding which species of a patient's bodily fluid should be monitored;
preparing a microfluidic bodily fluid reader for analysis of the species to be monitored;
saving patient history and patient's current state;
testing the patient with the microfluidic bodily fluid reader;
analyzing patient data based on the testing and issuing an alert in case an abnormality is found;
further analyzing the patient data for trends indicating that other tests should be added or removed; and
adding or removing the other tests through personalization of the microfluidic bodily fluid reader.

16. The method of claim 15, wherein patient data is also monitored for long term trends and a further alert is issued in case a long term trend abnormality is found.

17. The method of claim 15, wherein the bodily fluid is selected from the group consisting of blood, saliva, urine, vaginal fluids, breast milk, pus, tears, earwax, mucous, feces and semen.

18. The method of claim 15, wherein the species is a protein.

19. The method of claim 15, wherein the step of further analyzing the patient data for trends indicating that other tests should be added or removed comprises
comparing the patient data to anonymous data to determine how the patient is doing with regards to one or more statistical cohorts; and
based on comparison between the patient data and the anonymous data changing testing of the patient or warning the patient.

20. The method of claim 15, wherein the step of further analyzing the patient data for trends indicating that other tests should be added or removed comprises adding additional tests in order to perform research across specific groups of individuals with certain characteristics of interest to researchers.

21. The method of claim 15, wherein the step of further analyzing the patient data for trends indicating that other tests should be added or removed comprises identifying sub populations of patients that will and will not benefit from a certain drug.

22. A large scale medical data monitoring method, comprising:
searching for different species or components in a bodily fluid of a patient, through insertion of the bodily fluid in a microfluidic bodily fluid reader;
receiving medical data from the microfluidic reader at a local computer analysis unit;
sending received medical data from the local computer analysis unit to a centralized server; and
comparing medical data of people in a first category with medical data of people in a second category to determine whether the people in the first category have a good response to a certain drug with respect to the people in the second category.

23. The method of claim 22, wherein the first category is a category of overexpressors containing people who overexpress a certain protein.

24. The method of claim 22, wherein the step of comparing medical data is to compare drugs.

25. A method for periodically monitoring a disease marker, comprising:
searching for the disease marker through a microfluidic bodily fluid reader programmable to search for different species or components in a bodily fluid inserted in the microfluidic bodily fluid reader;
analyzing data from the microfluidic bodily fluid reader at a local computer analysis unit, the local computer analysis unit configured to be connected to a centralized server;
alerting a doctor if the disease marker appears; and
further performing the searching periodically.
